(19) United States
(12) Patent Application Publication
(10) Pub. No.: US 2024/0318748 A1
(43) Pub. Date: Sep. 26, 2024

(54) PLASTIC PIPE AND PLASTIC SLEEVE FOR CONNECTING TO SUCH A PLASTIC PIPE

(71) Applicant: Ralph Peter Hegler, Bad Kissingen (DE)

(72) Inventor: Ralph Peter Hegler, Bad Kissingen (DE)

(21) Appl. No.: 18/612,139

(22) Filed: Mar. 21, 2024

(30) Foreign Application Priority Data
Mar. 21, 2023 (DE) 10 2023 202 512.4

(51) Int. Cl. F16L 9/12

(52) U.S. Cl. CPC F16L 9/12

(57) ABSTRACT

A plastic pipe is designed with a plurality of chambers each extending along a pipe longitudinal axis, with elevations orientated to be perpendicular to the pipe longitudinal axis on an outer side of the pipe and with an anti-rotation member arranged at the elevations and extending to be parallel to the pipe longitudinal axis. A corresponding plastic sleeve serves for connecting to the plastic pipe and comprises a sleeve longitudinal axis, an axial stop element for axial abutment of the plastic pipe in the plastic sleeve, a sleeve pipe section adjoining the axial stop element and an insertion section widening towards an insertion opening, wherein an anti-rotation countermember corresponding to the anti-rotation member of the plastic pipe is arranged on an inner wall of the sleeve pipe section.

### CROSS-REFERENCES TO RELATED APPLICATIONS

This application claims the priority of German Patent Application, Serial No. DE 10 2023 202 512.4, filed Mar. 21, 2023, the content of which is incorporated herein by reference in its entirety as if fully set forth herein.

### FIELD OF THE INVENTION

The invention relates to a plastic pipe and a plastic sleeve for connecting to such a plastic pipe.

### BACKGROUND OF THE INVENTION

DE 10 2013 109 111 A1 discloses a multiple lumen hose.

EP 2 960 387 A1 discloses a pipe connection kit.

U.S. Pat. No. 5,305,797 discloses a construction kit for tube elements.

DE 10 2009 056 975 B3 discloses a tubular component.

U.S. Pat. No. 3,578,777 discloses a corrugated tubing.

US 2006/0254663 A1 discloses a corrugated tube with variable stiffness.

Pipes with internal chambers, also known as multi-channels, are used, for example, for water treatment in wastewater technology or as cable protection pipes. When connecting pipes with multi-channels axially, the pipes must be positioned precisely in relation to each other in order to ensure the functionality of the multi-channels. In the case of seepage pipes, so-called apex markings are printed on or incorporated as colored strips, for example during the extrusion of composite pipes. The apex markings enable pipes to be arranged at an exact angle one behind the other, but cannot prevent incorrect installation as a result of inaccurate working methods.

### SUMMARY OF THE INVENTION

It is an object of the invention to improve the angularly accurate axial connection of plastic pipes with multi-channels and, in particular, to make it fail-safe.

This object is achieved by a plastic pipe comprising a plurality of chambers each extending along a pipe longitudinal axis, elevations orientated so as to be perpendicular to the pipe longitudinal axis on an outer side of the pipe, an anti-rotation member arranged at the elevations and extending parallel to the pipe longitudinal axis and by a plastic sleeve for connecting to a plastic pipe according to the invention, wherein the plastic sleeve comprises a sleeve longitudinal axis, an axial stop member for axial abutment of the plastic pipe in the plastic sleeve, a sleeve pipe section adjoining the axial stop member, an insertion section widening towards an insertion opening, wherein an anti-rotation countermember corresponding to the anti-rotation member of the plastic pipe is arranged on an inner wall of the sleeve pipe section.

According to the invention, it has been recognized that a connection of plastic pipes positioned axially one behind the other with a precise angle of rotation in the circumferential direction with respect to a pipe longitudinal axis can be carried out in a fail-safe manner if a plastic pipe has an anti-rotation member. The anti-rotation member is attached to elevations arranged on the outside of the pipe. The elevations are corrugations or ribs that are orientated to be perpendicular to the pipe longitudinal axis. The anti-rotation member guarantees mechanical anti-rotation protection for the plastic pipe. In particular, the anti-rotation member is arranged eccentrically with respect to the pipe longitudinal axis in a plane perpendicular to the pipe longitudinal axis. The anti-rotation member has a radial distance to the pipe longitudinal axis in the plane orientated to be perpendicular to the pipe longitudinal axis. The anti-rotation member extends parallel to the pipe longitudinal axis, i.e. it is orientated axially.

In particular, at least one elevation includes the anti-rotation member.

In particular, several elevations each have an anti-rotation member. The anti-rotation member is arranged at an axial position with respect to the pipe longitudinal axis at which an anti-rotation member is also arranged. In particular, the plastic pipe has a rotationally symmetrical outer contour in areas free of elevations, i.e. in particular in areas that are formed axially between two adjacent elevations. In particular, the axial intermediate area is designed to be free of anti-rotation members.

The anti-rotation member has an axial length that is in particular greater than an axial distance between two axially adjacent elevations. This means that several, in particular at least two, axially adjacent elevations comprise the anti-rotation member.

Accordingly, a plastic sleeve according to the invention has an anti-rotation countermember which corresponds to the anti-rotation member of the plastic pipe. The plastic pipe is definitely fixed with the anti-rotation member to the anti-rotation countermember of the plastic sleeve in a rotational angle position with respect to the pipe longitudinal axis. An unintentionally twisted and/or inaccurate arrangement of the plastic pipes in relation to each other in the circumferential direction with respect to the pipe longitudinal axis is reliably ruled out. The connection of the plastic pipes is fail-safe.

The plastic pipe according to the invention and the plastic sleeve according to the invention enable an axial connection to each other according to a tongue and groove principle. This connection technique is uncomplicated, mechanically robust and can be handled intuitively.

A connection of multi-channels in the plastic pipe that is accurate to the angle of rotation is ensured. The multi-channels are chambers in the pipe interior of the plastic pipe. The chambers each extend axially, i.e. along the pipe longitudinal axis. In particular, the chambers are separated from each other by at least one separating member in the pipe interior.

A plastic pipe in which the anti-rotation member is formed as a groove or as a web at the elevations enables uncomplicated production. The anti-rotation member extends in particular in a radial direction with respect to the pipe longitudinal axis, in particular as a radial depression, in particular as an external groove, or as a radial elevation, in particular in the form of an external web. The anti-rotation member is directly perceptible visually and haptically.

A plastic pipe in which the anti-rotation member is molded in one piece at the elevations enables uncomplicated production, in particular by extrusion. The fact that the anti-rotation member is molded in one piece makes it mechanically robust. The anti-rotation member is formed to be integral. Additional production steps are not required.

A plastic pipe in which the anti-rotation member is designed to be axially continuous ensures a stable connection technology. In particular, the anti-rotation member extends along the entire length of the plastic pipe. Production is possible in a particularly uncomplicated and continuous manner.

An embodiment of the anti-rotation member in which the anti-rotation member has a rectangular, V-shaped or semi-circular contour in a plane orientated perpendicular to the pipe longitudinal axis simplifies the axial connection with the plastic sleeve.

The embodiment of the anti-rotation member in which the anti-rotation member has a contour in a plane orientated perpendicular to the pipe longitudinal axis, the corners of which contour are rounded with a radius, wherein the radius is in particular at least 2.0 mm, avoids stress peaks in the plastic material and/or production-related defects.

The embodiment of a plastic pipe in which the plastic pipe is designed as a composite pipe or as a ribbed tube enables a wide range of applications, in particular in the field of wastewater technology.

A plastic pipe comprising at least one guide element, in particular of integral design, arranged on an inner pipe side for holding at least one separating member simplifies the production of the multi-channels. At least one separating member can be held, in particular detachably held, on at least one guide member arranged on the pipe inner side. In particular, the separating member can be pushed axially into the pipe. In particular, the separating member can be removed from the pipe again. Assembly and/or disassembly of the plastic pipe with separating member is simplified and possible without any effort. In particular, the separating member can be removed from the plastic pipe in a non-destructive manner. The at least one guide member is integrally formed on the pipe inner side. In particular, the guide member and anti-rotation member are arranged at different rotation angle positions in the circumferential direction around the pipe longitudinal axis, in particular with a rotation angle offset of 90°. A different rotation angle offset or no rotation angle offset can also be selected.

A plastic sleeve for connecting to a plastic pipe according to the invention, wherein the plastic sleeve comprises a sleeve longitudinal axis, an axial stop member for axial abutment of the plastic pipe in the plastic sleeve, a sleeve pipe section adjoining the axial stop member, an insertion section widening towards an insertion opening, wherein an anti-rotation countermember corresponding to the anti-rotation member of the plastic pipe is arranged on an inner wall of the sleeve pipe section, ensures the fail-safe positioning with respect to the plastic pipe according to the invention and enables the fail-safe connection to the plastic pipe. The plastic sleeve has an axial stop member on which the plastic pipe is axially fixed in the plastic sleeve, in particular by axial abutment. The axial stop member is an abutment shoulder.

The axial stop member is adjoined by a sleeve pipe section which can be designed to be cylindrical and/or conical with respect to a sleeve longitudinal axis, wherein a conicity angle is small and in particular less than 5°, in particular less than 3° and in particular less than 1°.

The plastic sleeve has an insertion opening where the plastic pipe is inserted. An expanding insertion section is arranged towards the insertion opening. It is essential that the anti-rotation countermember is arranged on an inner wall of the sleeve pipe section and thus ensures the anti-rotation arrangement of the plastic pipe.

In particular, the anti-rotation countermember has an axial length that is greater than an axial distance between two adjacently arranged elevations on the plastic pipe. This means that when the plastic pipe is coupled to the plastic sleeve, the anti-rotation countermember interacts with at least two axially adjacently arranged elevations, in particular the anti-rotation members thereof. In particular, the anti-rotation countermember engages with the anti-rotation member in a radial direction or vice versa.

A plastic sleeve in which a sealing section facing the axial stop member is formed on the sleeve pipe section in the direction of the sleeve longitudinal axis, which is designed to be free of anti-rotation countermembers, ensures sealing of the plastic pipe in the plastic sleeve. It has been recognized that a sealing section, which is arranged along the sleeve longitudinal axis between the axial stop member and the sleeve pipe section, can be designed to be free of anti-rotation countermembers, in particular to be cylindrical. A profiled sealing ring can be reliably and sealingly arranged in the sealing section.

A plastic sleeve in which the plastic sleeve is designed as a double plug-in sleeve or as a connection sleeve molded in one piece on a composite pipe enables various advantageous connection techniques.

An assembly including a plastic pipe as described above and a plastic sleeve connected to the plastic pipe in a non-rotatable manner as described above has the advantages of the plastic pipe and the plastic sleeve, to which reference is hereby made. In the assembly, the plastic pipe is arranged with the pipe longitudinal axis in a coaxial manner to the sleeve longitudinal axis of the plastic sleeve.

Further features, advantages and details of the invention will become apparent from the following description of embodiment examples with reference to the drawing.

### BRIEF DESCRIPTION OF THE DRAWING

FIG. 1 shows an apparatus for the continuous production of a plastic pipe according to the invention with a connection sleeve molded in one piece,

FIG. 2 shows a longitudinal section of an extrusion head of the apparatus in FIG. 1,

FIG. 3 shows a partially sectioned side view of a plastic pipe produced in the apparatus according to FIGS. 1 and 2 according to a first embodiment example with a connection sleeve molded in one piece,

FIG. 4 shows a sectional view according to section line IV-IV in FIG. 3,

FIG. 5 shows a sectional view according to section line V-V in FIG. 3,

FIG. 6 shows an enlarged detailed view of an anti-rotation member according to a first embodiment example on the plastic pipe in FIG. 5,

FIGS. 7 and 8 shows further embodiment examples of an anti-rotation member,

FIG. 9 shows an illustration of an arrangement corresponding to FIG. 3 with the plastic pipe arranged in the connection sleeve according to FIG. 3 so as to prevent it from rotating,

FIG. 10 shows a sectional view according to section line X-X in FIG. 9,

FIG. 11 shows an illustration of a plastic pipe corresponding to FIG. 3 according to a further embodiment example,

FIG. 12 shows a partially sectioned longitudinal view of a plastic sleeve according to a further embodiment example as a double plug-in sleeve,

FIG. 13 shows a view according to arrow XIII in FIG. 12,

FIG. 14 shows a partially sectioned side view of an arrangement with the plastic pipe according to FIG. 11 in the double plug-in sleeve according to FIG. 12,

FIG. 15 shows a sectional view according to section line XV-XV in FIG. 14.

### DESCRIPTION OF THE PREFERRED EMBODIMENTS

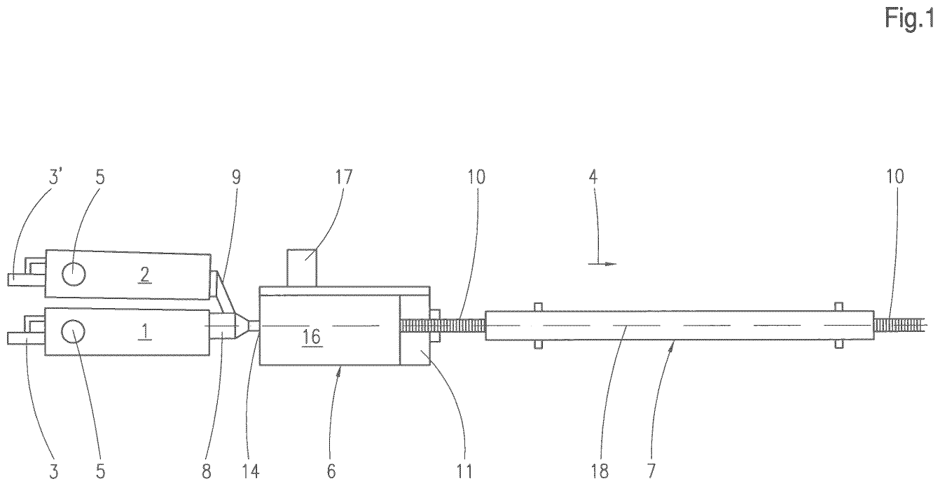

An apparatus shown in FIG. 1 for the production of composite pipes has two extruders 1, 2. These are each driven by a variable-speed drive motor 3, 3′, which—in relation to a conveying direction 4 of the entire apparatus—is provided upstream of feed hoppers 5 of the extruders 1, 2.

A molding machine 6, a so-called corrugator, is arranged downstream of the extruders 1, 2 in relation to the conveying direction 4, which in turn is followed by a post-cooling apparatus 7. A transverse injection head 8, which projects into the molding machine 6, is attached to an extruder 1 arranged in alignment with the molding machine 6 and the post-cooling apparatus 7. The other extruder 2, arranged to the side of this extruder 1, is connected to the transverse injection head 8 via an injection channel 9 that opens into the side of the transverse injection head 8. As schematically indicated in FIG. 1, a composite pipe 10 is formed in the molding machine 6, which emerges from the molding machine 6 in the conveying direction 4 and is cooled in the post-cooling apparatus 7. Downstream of this post-cooling apparatus 7, it can then be cut into pieces of a suitable length. The structure of the molding machine 6 is known and is described, for example, in EP 0 563 575 A2, to which express reference is made.

It essentially comprises a machine table 11 on which half molds 12, 12′ are arranged, each of which are connected to each other to form two so-called chains 13, 13′. These chains 13, 13′ are guided via deflection rollers—not shown—at the upstream inlet end 14 in relation to conveying direction 4 and at their downstream outlet end. During the circulation in the conveying direction 4, they are guided in such a manner that in each case two half-molds 12, 12′ are combined to form a pair of molds, wherein in turn pairs of molds following one another in the conveying direction 4 are located close together. A drive motor 17 drives the half-molds 12, 12′, which are brought together on a molding section 16 to form pairs of molds.

The transverse injection head 8 has two melt channels arranged concentrically to a common central longitudinal axis 18, namely an inner melt channel 19 and an outer melt channel 20, which—in relation to the conveying direction 4—end downstream in an inner nozzle 21 and an outer nozzle 22 respectively. The inner melt channel 19 is connected to an injection channel 23 of the extruder 1 arranged in alignment with the molding machine 6, whereas the outer melt channel 20 is connected to the injection channel 9 of the other extruder 2.

A calibration mandrel 24, which also extends concentrically to the central longitudinal axis 18, is attached to the downstream end of the injection head 8 in relation to the conveying direction 4. It has cooling channels 25 for cooling medium, in particular cooling water, which is supplied via a cooling water supply line 26 and discharged via a cooling water return line 27. The lines 26, 27 can be routed through an approximately tubular supply channel formed concentrically to the central longitudinal axis 18 in the injection head 8.

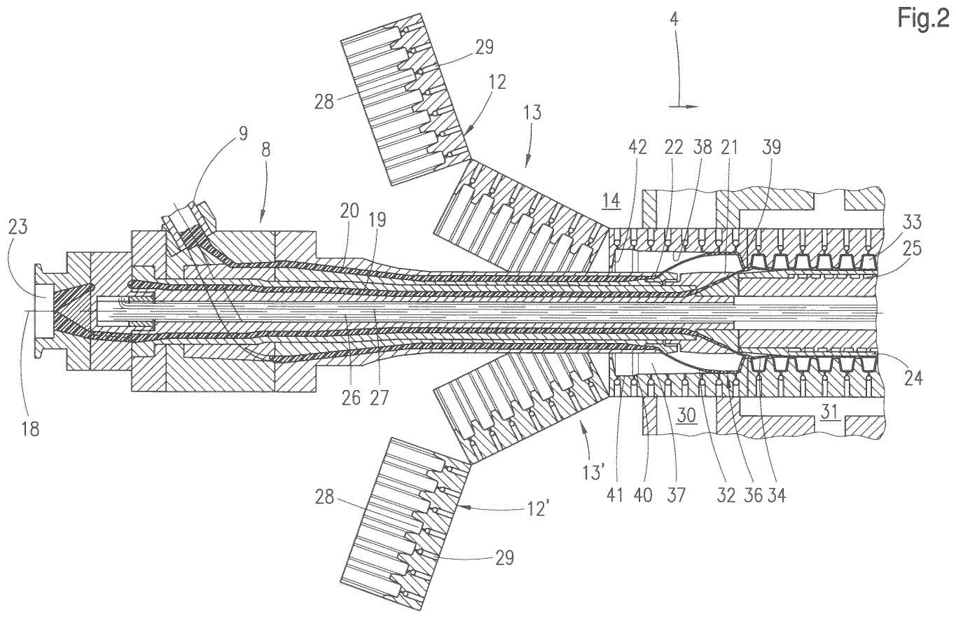

The half molds 12, 12′ have ring-shaped mold recesses 28 which are arranged at regular intervals one behind the other and which are each connected to partial vacuum channels 29. When the half molds 12, 12′ enter the molding section 16, the partial vacuum channels 29—as can be seen in FIG. 2—reach partial vacuum supply sources 30, 31, so that the mold recesses 28 are subjected to partial vacuum.

The plastic melt fed from the extruder 2 through the injection channel 9 to the injection head 8 flows through the outer melt channel 20 to the outer nozzle 22 and is extruded there, forming an external pipe 32. Due to the partial vacuum, the external pipe 32 settles into the mold recesses 28, forming a pipe with transverse grooves. The transverse grooves form elevations 33 on the pipe outer surface. Plastic melt is fed from the extruder 1 through the injection channel 23 to the transverse injection head 8 and flows through the inner melt channel 19 to the inner nozzle 21, where it emerges as an internal pipe 34, which reaches the calibrating mandrel 24. The latter expands slightly outwards from the inner nozzle 21 in the conveying direction 4 until the internal pipe 34 reaches the corrugation troughs 35 of the external pipe 32 and is welded thereto.

After cooling and solidification, the internal pipe 34 and the external pipe 32 form a pipe base body of the composite pipe 10.

The composite pipe 10 has a pipe longitudinal axis 15. In the composite pipe 10, the internal pipe 34 is welded to the external pipe 32 in the region of the corrugation troughs 35. In the external pipe 32, the transverse grooves are formed as elevations 33 orientated to be perpendicular to the pipe longitudinal axis 15. The external pipe 32 forms a pipe outer side of the composite pipe 10. The internal pipe 34 is cylindrical with respect to the pipe longitudinal axis 15 with a substantially smooth pipe inner side 43.

The internal pipe 34 has an integrally formed, i.e. integrally molded, guide member 44 on the pipe inner side 43. The contour of the guide member 44 can be produced in particular by means of a molded structure of the calibration mandrel 24, which is not shown in detail, using an extrusion method. The contour of the guide member 44 corresponds to the contour of the molded structure on the calibration mandrel 24. The guide member 44 extends parallel to the pipe longitudinal axis 15. The guide member 44 is axially oriented. The guide member 44 forms a guide web or a guide rail.

The guide member 44 projects into the pipe interior enclosed by the pipe base body, in particular in a radial direction with respect to the pipe longitudinal axis 15, with a first height h1 which is at least 1.0% of the inner diameter di of the internal pipe 34.

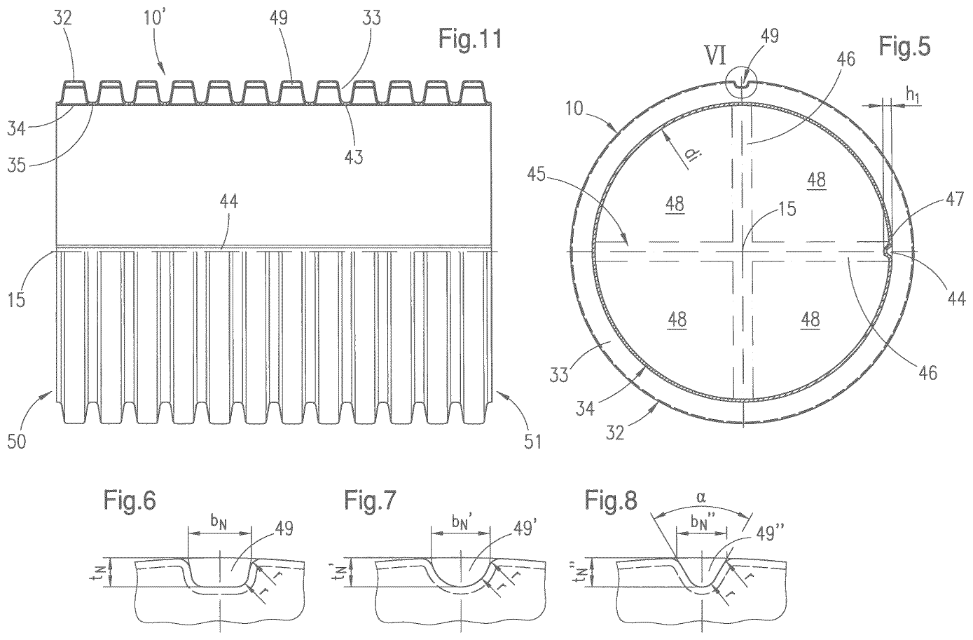

A separating member 45, shown dashed in FIG. 5, is held on the guide member 44. The separating member 45 is designed as a cross profile and is arranged concentrically to the pipe longitudinal axis 15. The separating member 45 has two intersecting webs 46, which are connected to each other in a central position and in one piece. The separating member 45 can also have a different profile shape and in particular be plate-shaped. It can be advantageous if a plurality of guide members 44 are arranged along the inner circumference of the pipe inner side 43 in order to improve the retention of the separating member 45.

The web 46 facing the guide member 44 has an end face contour 47 corresponding to the guide member 44, with which the separating member 45 can be pushed into the internal pipe 34 and is held on the guide member 44. The separating member 45 is held in the composite pipe 10 so as to be non-rotatable and angularly accurate with respect to the pipe longitudinal axis 15. The separating member 45 is used to divide the pipe interior of the composite pipe 10 into four, in particular equally sized, partial channels 48. The partial channels 48 are also referred to as multi-channels. The guide member 44 ensures that the separating member 45 is prevented from rotating with respect to the pipe longitudinal axis 15. The three remaining end faces of the webs 46 support the separating member 45 on the pipe inner side 43. The separating member 45 is robustly arranged in the pipe base body. An unintentional change in the rotational position of the separating member 45 with respect to the pipe longitudinal axis 15 is reliably prevented.

An anti-rotation member 49 in the form of an external groove is formed on the external pipe 32 at the elevations 33. The anti-rotation member 49 forms a radial recess with respect to the pipe longitudinal axis 15. The anti-rotation member 49 is arranged eccentrically with respect to the pipe longitudinal axis 15 at a radial distance from the pipe longitudinal axis 15. In the axial direction, the anti-rotation member 49 is designed along a plurality of elevations 33. In particular, the anti-rotation member 49 extends in the axial direction starting from a first pipe end 50, in particular continuously up to an opposite second pipe end 51 or up to the pipe sleeve 36 molded onto the composite pipe 10.

Alternatively, the anti-rotation member 49 can be designed as a web in an embodiment example not shown. Accordingly, the elevations 33 in the region of the anti-rotation member are designed to be raised radially with respect to the pipe longitudinal axis 15.

The outer groove has a groove depth t and a groove width b_{N}. In the embodiment of the outer groove 49 according to FIGS. 5 and 6, which has an essentially rectangular groove cross-section, the groove depth t is approximately half as large as the groove width b_{N}. In particular, the following applies: t_{N}=1.0× b_{N} . . . 3.0×b_{N}. As shown in FIG. 6 in particular, the corners of the groove cross-section are rounded with rounding radii r. In particular, a uniform rounding radius r is used, which in particular is at least 2.0 mm.

According to the embodiment example in FIG. 7, the groove cross-section of the anti-rotation member 49′ is semi-circular, wherein the groove depth t_{N}′ is approximately half the groove width b_{N}′. With a V-shaped cross-section of the outer groove 49″ according to FIG. 8, the groove depth t_{N}″ is comparatively greater and is between 50% and 100% of the groove width b_{N}″. An opening angle α of the V-shape is between 30° and 90°, in particular between 45° and 75° and in particular 60°.

As can be seen in particular in FIG. 2, the half molds 12, 12′ are formed in such a manner that pipe sleeves 36 are formed in each case at predetermined intervals within the continuously produced composite pipe 10. For this purpose, in a pair of half molds 12, 12′ a substantially cylindrical sleeve recess 37 is formed, which thus has a substantially smooth, cylindrical wall 38.

A transition section 39 is formed between the wall 38 of the sleeve recess 37 and the mold recess 28, which leads in the conveying direction 4. A frustoconical molded section 40 adjoins the end of the wall 38 of the sleeve recess 37 that is lagging behind in the conveying direction 4, in which molded section 40 an outwardly widening insertion end 41 of the sleeve 36 is formed. This, in turn, is followed by a transition section 42, which leads to the next mold recess 28, which follows in the conveying direction 4.

Insofar as the apparatus has been described up to this point, it is essentially known from EP 0 995 579 A2, express reference to which is made.

The plastic sleeve 36 is molded in one piece on the composite pipe 10. The sleeve 36 is also referred to as a connection sleeve. The sleeve 36 has a sleeve longitudinal axis 52, which coincides with the pipe longitudinal axis 15 of the integrally molded composite pipe 10. The sleeve 36 has an insertion opening 53 opposite the first pipe end 50, which is arranged as the open end of an insertion section 54 that widens towards the insertion opening 53. The insertion section 54 is designed to widen conically with respect to the sleeve longitudinal axis 52 with a half opening angle ß between 10° and 25°.

The insertion section 54 is initially followed by a sleeve pipe section 55 and then a sealing section 56. The sleeve pipe section 55 is configured to be cylindrical and/or slightly conically widening, at least in sections, with respect to the sleeve longitudinal axis 52. An anti-rotation countermember 58 is formed on an inner wall 57 of the sleeve pipe section 55 and, in particular, is formed in one piece at the sleeve pipe section 55. The anti-rotation countermember 58 is in the form of a raised structure which protrudes from the inner wall 57 of the sleeve pipe section 55 in a radial direction with respect to the sleeve longitudinal axis 52. The anti-rotation countermember 58 is designed as a web that projects radially from the inner wall 57. The anti-rotation countermember 58 is designed with a rectangular profile cross-section that corresponds to the groove contour of the anti-rotation member 49 according to FIGS. 5 and 6. In particular, the external dimensions of the anti-rotation countermember 58 are slightly smaller than the internal dimensions of the anti-rotation member 49. The anti-rotation member 49 is arranged to fit precisely on the anti-rotation countermember 58. The anti-rotation countermember 58 is arranged eccentrically with respect to the sleeve longitudinal axis 52, i.e. in particular with a radial distance.

The anti-rotation countermember 58 has an axial insertion bevel 61 facing the insertion opening 53. The anti-rotation countermember 58 has an axial length L that is greater than an axial distance Da between two adjacent elevations 33 of a corresponding plastic pipe 10. This ensures that the anti-rotation countermember 58 is arranged on the anti-rotation member 49 at two elevations 33 arranged adjacent in the axial direction. The anti-rotation protection is therefore particularly robust mechanically.

The sealing section 56 is designed without anti-rotation countermembers. In particular, this means that the inner wall 57 is completely cylindrical throughout in the region of the sealing section 56.

In the axial direction with respect to the sleeve longitudinal axis 52, the sealing section 56 is adjoined by an extension section 59, which represents a diameter transition from the internal pipe 34 of the composite pipe 10 to the outer wall of the sleeve 36. The extension section 59 serves as an axial stop member for the sleeve 36. The axial stop member 59 is used to define a maximum axial insertion depth of the composite pipe 10 at the sleeve 36.

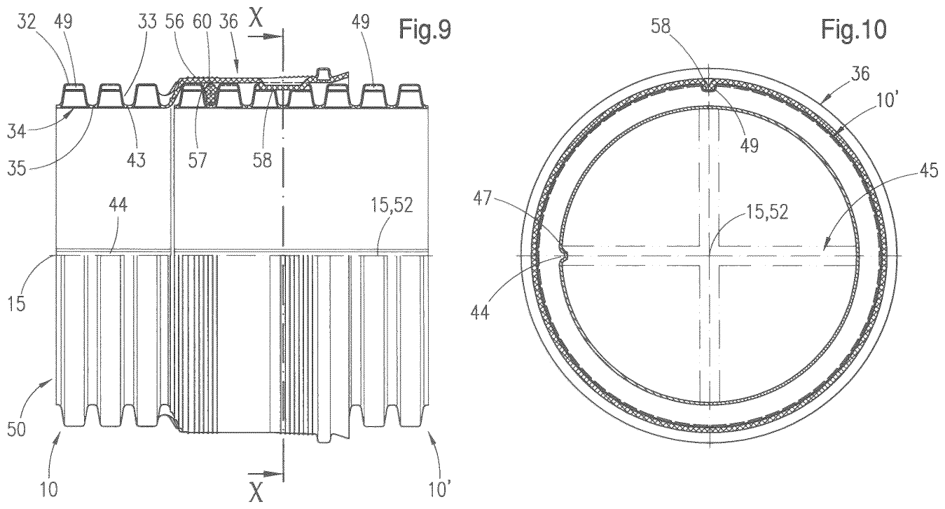

In the assembly comprising the composite pipe 10 and the integrally moulded connection sleeve 36 in FIG. 9, a further composite pipe 10′ is inserted axially into the connection sleeve 36. The composite pipe 10′ has an anti-rotation member 49 which corresponds to the anti-rotation countermember 58 of the sleeve 36. The web-like anti-rotation countermember 58 engages in the groove-shaped anti-rotation member 49 and thus ensures reliable anti-rotation protection of the composite pipe 10′ relative to the composite pipe 10. In particular, it is not possible to position the composite pipe 10′ at a different angle of rotation relative to the sleeve 36 than that shown in FIG. 10.

Due to the fact that no anti-rotation countermembers 58 are arranged in the sealing section 56, it is possible to arrange a sealing element 60, in particular in the form of a profiled sealing ring, between two elevations 33 of the composite pipe 10′. The sealing of the composite pipe 10′ in the sleeve 36 is reliably ensured. The profiled sealing ring 60 can reliably seal against the circular cylindrical smooth inner wall 57 in the region of the sealing section 56.

The plastic pipe 10 can also be designed as a ribbed tube with corresponding fin-shaped elevations. Such a ribbed tube is known from EP 0 531 750 A2 and its production from DE 2450171 C2, to which explicit reference is hereby made.

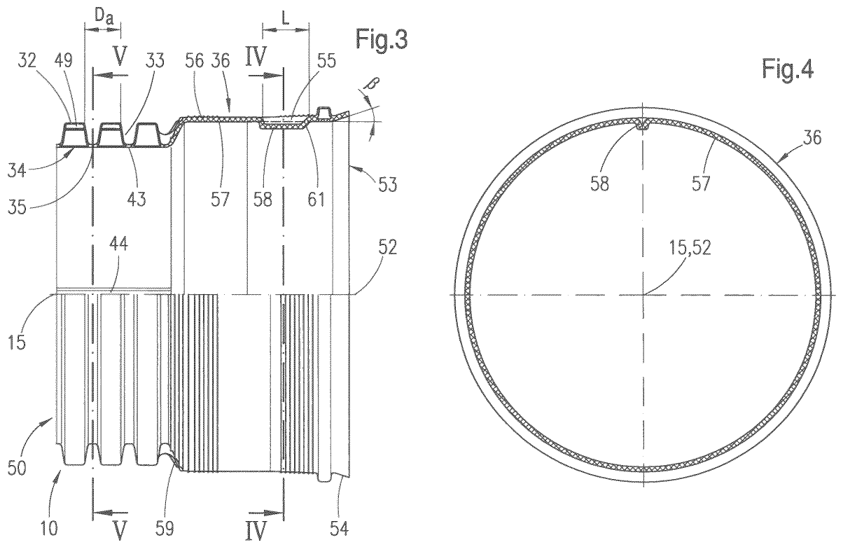

The composite pipe 10′ is shown separately in FIG. 11. It differs from the composite pipe 10 shown in FIG. 3 in that no connection sleeve is molded on. In the composite pipe 10′, the anti-rotation member 49 is configured to be completely axially continuous.

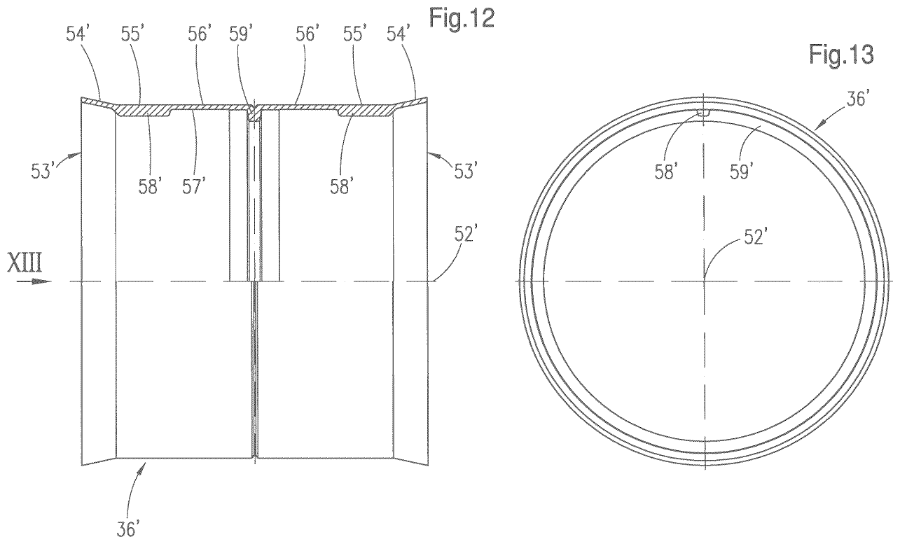

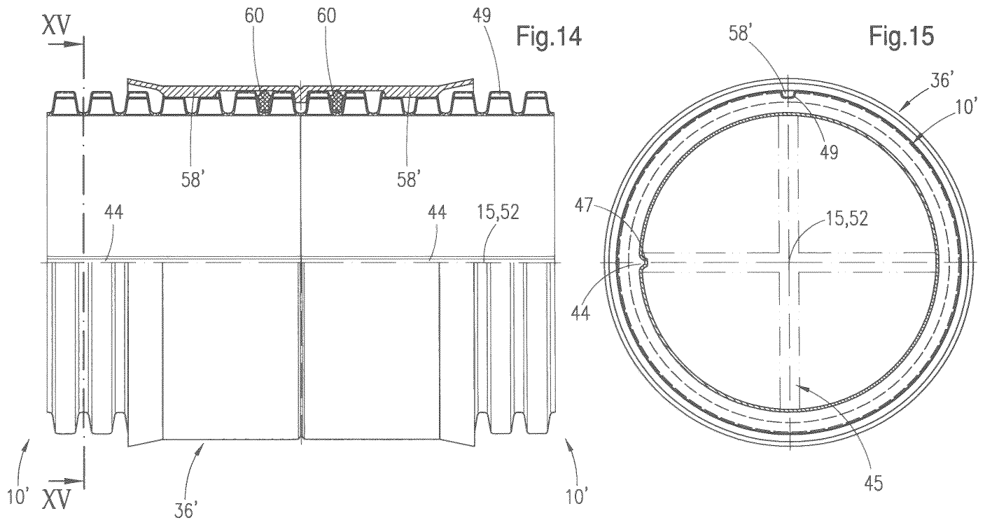

A plastic sleeve 36′ according to FIGS. 12 and 13, which is designed as a double plug-in sleeve, is used to connect two connection pipes 10′. The double plug-in sleeve 36′ accordingly has two insertion openings 53′ arranged to face away from each other, corresponding insertion sections 54′, sleeve pipe sections 55′, sealing sections 56′ and an axial stop member 59′, in particular arranged axially in the center. The axial stop member 59′ is designed as an inner web that has a web height that is greater than the groove depth of the anti-rotation members 49. The axial stop member 59′ forms an annular abutment shoulder that provides reliable and stable axial protection for the composite pipes 10′. In particular, the axial stop member 59′ is designed with a corresponding axial width, so that composite pipes 10′ connected to the double plug-in sleeve 36′ are connected to each other with their ends abutting.

What is claimed is:

1. A plastic pipe comprising
a. a plurality of chambers each extending along a pipe longitudinal axis,
b. elevations orientated so as to be perpendicular to the pipe longitudinal axis on an outer side of the pipe,
c. an anti-rotation member arranged at the elevations and extending parallel to the pipe longitudinal axis.

2. The plastic pipe according to claim 1, wherein the anti-rotation member is formed one of as a groove and as a web at the elevations.

3. The plastic pipe according to claim 1, wherein the anti-rotation member is molded in one piece at the elevations.

4. The plastic pipe according to claim 1, wherein the anti-rotation member is designed to be axially continuous.

5. The plastic pipe according to claim 1, wherein the anti-rotation member has one of a rectangular, V-shaped and semi-circular contour in a plane orientated perpendicular to the pipe longitudinal axis.

6. The plastic pipe according to claim 1, wherein the anti-rotation member has a contour in a plane orientated perpendicular to the pipe longitudinal axis, the corners of which contour are rounded with a radius (r).

7. The plastic pipe according to claim 6, wherein the radius (r) is at least 2.0 mm.

8. The plastic pipe according to claim 1, wherein the plastic pipe is designed one of as a composite pipe and as a ribbed tube.

9. The plastic pipe according to claim 1, comprising at least one guide element, arranged on an inner pipe side for holding at least one separating member.

10. The plastic pipe according to claim 9, wherein the at least one guide element is of integral design.

11. A plastic sleeve for connecting to a plastic pipe according to claim 1,
wherein the plastic sleeve comprises
a. a sleeve longitudinal axis,
b. an axial stop member for axial abutment of the plastic pipe in the plastic sleeve,
c. a sleeve pipe section adjoining the axial stop member,
d. an insertion section widening towards an insertion opening,
wherein an anti-rotation countermember corresponding to the anti-rotation member of the plastic pipe is arranged on an inner wall of the sleeve pipe section.

12. The plastic sleeve according to claim 11, wherein a sealing section facing the axial stop member is formed on the sleeve pipe section in the direction of the sleeve longitudinal axis, which is designed to be free of anti-rotation countermembers.

13. The plastic sleeve according to claim 11, wherein the plastic sleeve is designed as a double plug-in sleeve.

14. The plastic sleeve according to claim 11, wherein the plastic sleeve is designed as a connection sleeve molded in one piece on a composite pipe.

15. An assembly including
a plastic pipe comprising:
a. a plurality of chambers each extending along a pipe longitudinal axis,
b. elevations orientated so as to be perpendicular to the pipe longitudinal axis on an outer side of the pipe,
c. an anti-rotation member arranged at the elevations and extending parallel to the pipe longitudinal axis, and
a plastic sleeve connected to the plastic pipe in a non-rotatable manner according to claim 11.
